(19) United States
(12) Patent Application Publication
(10) Pub. No.: US 2009/0041913 A1
(43) Pub. Date: Feb. 12, 2009

(54) METHOD FOR PRODUCING A FILLED CONSUMABLE PRODUCT

(76) Inventors: Rainer Weber, Bergneustadt (DE); Daniel Walgarth, Siegburg (DE)

Correspondence Address: Klaus P. Stoffel, One Boland Drive, West ORange, NJ, 07052, US

(21) Appl. No.: 11/918,634

(22) PCT Filed: Feb. 1, 2006
(86) PCT No.: PCT/CH2006/000065

§ 371 Date: Oct. 15, 2007

(30) Foreign Application Priority Data
Apr. 13, 2005 (DE) 10 2005 017 178.8

(51) Int. Cl. A23G 3/20

(52) U.S. Cl. 426/279; 425/111

(57) ABSTRACT

The invention relates to a method and to a system for producing a filled consumable product, in particular a shell-like consumable product consisting of at least two different substances which form the covering and/or shell of the consumable product and the second filling the consumable product. Said method comprises the following steps: a) a covering, which comprises an opening, is produced; b) a filling is added to the covering via an opening; and c) a cover is applied to the opening in order to close the filled covering. The filling is added according to step b) and the cover is applied according to step c) which takes place simultaneously in one step. Means for adding the filling and means for applying the cover can be displaced together and at a constant distance according to the inventive system.

The invention relates to a method for manufacturing a filled consumable, in particular a shell-like consumable made up of at least two different substances, of which the first is a sheath or shell of the consumable, and the second is a filling for the consumable, e.g., pralines.

In the known “classic” methods, three consecutive procedural steps take place, namely sheath formation, sheath filling and cover production, for which a respective casting machine is used. This makes it possible to fabricate geometrically complicated product shapes and use substances with highly disparate properties, e.g., very different viscosities, for the sheath substance, filling substance and cover substance. However, the disadvantage to such methods is that at least three casting steps are required, and the remaining procedural steps also involve a relatively high operational outlay.

In order to reduce the equipment and procedural outlay for manufacturing pralines, a method was developed in which sheath formation, sheath filling and cover production take place in a single procedural step, or with only a single “shot”. In this so-called one-shot process, a single die having a central tube and channel enveloping the central tube is used to introduce the chocolate for the sheath via the channel and the filling via the tube into a mold in a shot. This yields a praline for which the chocolate completely surrounds the filling. While this enables the manufacture of a complete product in only one casting step, this process is not suitable for processing substances with similar viscosities, and only relatively simple geometric product shapes with relatively irregular sheath wall thicknesses can be fabricated. These and similar processes are known from DE 197 32 593 or FR 11 32 821, for example.

The object of the invention is to provide a method for manufacturing a filled consumable of the kind described at the outset that still allows the manufacture of geometrically complicated product shapes with precise and uniform wall thickness formation at a justifiable outlay.

This object is achieved according to claim 1 by a method for manufacturing a filled consumable, wherein the method involves the following steps:

a) Manufacturing a sheath with a sheath opening;

b) Metering a filling into the sheath via the sheath opening; and

c) Applying a cover or protective layer to the sheath opening to seal the filled sheath.

According to the invention, the filling is introduced according to step b) and the cover or protective layer is applied according to step c) simultaneously in a single procedural step.

As a result, only two casting machines are required, namely a first casting machine for manufacturing the sheaths according to step a), and a second casting machine for simultaneously metering the filling into the sheaths and applying the cover or protective layer to seal the filled sheaths. In step c), a very thin protective layer can also be applied, e.g., consisting of a highly fatty chocolate, which replaces a “spraying process” to enable a subsequent “covering” with an additional machine. One less machine (spraying machine) has to be used in this case as well.

In addition, the substance for sheath manufacture can exhibit properties differing form the two substances for the filling and the cover, in particular have another viscosity at the usual processing temperatures, which enables a greater variety of substance combinations, and hence a wider range of products than in the one-shot method described at the outset.

The sheath is preferably fabricated according to step a) via cold stamping. In the cold-stamping process, melted fatty substance is first metered into a mold or alveolus, so that the latter is partially filled with the melted substance. The partially filled mold is generally vibrated for a brief period to expel potential gas pockets and/or distribute the melted substance. A cooling body or cooling stamp is then lowered against the partially filled mold, wherein the cooling body penetrates into the cavity partially filled with the melted substance, and displaces the melted substance, which then becomes distributed in the cavity between the exterior surface of the cooling body and the interior surface of the mold. The stamp-like cooling body then remains for a short period in this lowered position, until the substance distributed in the cavity has hardened. The cooling body is then lifted again. The completely shaped sheath comprised of the hardened substance can then be removed from the mold for further processing, but is preferably left therein, so that it can thereupon be subjected to introducing the filling according to step b) and the simultaneously application of the cover according to step c).

Cold stamping makes it possible to manufacture geometrically complex sheath shapes that are not possible in the one-shot process, for example. A first casing machine is used for cold stamping.

The filling substance is preferably metered into the sheath via a first die, and the cover substance is incrementally cast on the filling substance via a second die. A second casting machine is used for filling and covering. The die geometries are similar or identical to those of the one-shot dies.

The method according to the invention is implemented using a system comprised of the following:

Means for fabricating a sheath with a sheath opening;

Means for metering the filling into the sheath via the sheath opening;

Means for applying a cover to the sheath opening to seal the filled sheath.

According to the invention, the means for metering in the filling and the means for applying the cover can be moved simultaneously at a constant distance apart.

The means for manufacturing the sheath is preferably a cold-stamping device with a first casting machine.

Such a cold-stamping device contains a cavity that can be filled with fatty substance in a free-flowing, tempered state. The interior surface of the cavity here determines the exterior surface of the sheath to be manufactured. In addition, the device comprises a stamp-like cooling body, which can be lowered into the mold. The exterior surface of the cooling body here determines the interior surface of the sheath to be manufactured.

The means for metering in the filling is preferably a first die, and the means for applying the cover is a second die, which comprise part of a second casting machine.

The two dies can be arranged tightly adjacent or concentric to each other. Preferred embodiments utilize a die arrangement that exhibit a central tube and a channel that envelops the tube and has an annular or polygonal cross section.

The concentric or side-by-side arrangement is suitable for the manufacture of “point” filled consumables, e.g., pralines with a round, square or other regular polygonal plan via point casting inside the sheath or into the sheath.

The two arrangements are also suitable for producing “linear” filled consumables, e.g., chocolate bars with a rectangular plan, via strip casting within the sheath or into the sheath.

Therefore, the invention makes it possible to manufacture a great variety of filled consumable products consisting of a sheath, filling and cover.

The sheath can consist of a fatty substance, especially chocolate. However, it can also be a backed good, e.g., a waffle shell. Both round, e.g., praline-like sheaths, as well as longitudinal bar-shaped sheaths can be manufactured with the method according to the invention.

The die arrangement can be concentric, as described further above. As an alternative, use can also be made of an eccentric die arrangement, in which the tube is not arranged in the middle of the cross section or in the enveloping channel, but rather eccentrically, i.e., away from the cross sectional midpoint. The cross section of the channel is then preferably elliptical or longitudinally polygonal.

1-9. (canceled)

10. A method for manufacturing a filled consumable made up of at least two different substances, of which the first is a sheath or shell of the consumable, and the second is a filling for the consumable, the method comprising the steps of:
a) manufacturing a sheath with a sheath opening;
b) metering a filling into the sheath via the sheath opening; and
c) applying a cover or protective layer to the sheath opening to seal the filled sheath, wherein step b) and step c) are carried out simultaneously in a single step.

11. The method according to claim 10, wherein step a) includes manufacturing the sheath by cold stamping.

12. The method according to claim 10, including metering the filling substance into the sheath via a first die, and incrementally casting the covering substance onto the filling substance via a second die.

13. The method according to claim 10, including metering or applying the filling substance and the covering substance via a die arrangement, which has a tube with a channel that envelops the tube, wherein the filling substance is guided via the tube, and the covering substance is guided via the channel to a metering location.

14. A system for manufacturing a filled consumable made up of at least two different substances, of which the first is a sheath or shell of the consumable, and the second is a filling for the consumable, wherein the system comprises:
means for fabricating a sheath with a sheath opening;
means for metering the filling into the sheath via the sheath opening; and
means for applying a cover to the sheath opening to seal the filled sheath, the means for metering the filling and the means for applying the cover can be moved simultaneously at a constant distance apart.

15. The system according to claim 14, wherein the means for fabricating the sheath is a cold-stamping device.

16. The system according to claim 14, wherein the means for metering the filling is a first die, and the means for applying the cover is a second die.

17. The system according to claim 14, wherein the metering and applying means are a die arrangement that includes a tube with a channel enveloping the tube.

18. The system according to claim 17, wherein the tube is centrally arranged in the channel, the channel having a circular or polygonal cross section.
